(19) United States
(12) Patent Application Publication
(10) Pub. No.: US 2025/0313411 A1
(43) Pub. Date: Oct. 9, 2025

(54) VIBRATORY APPARATUS

(71) Applicant: General Kinematics Corporation, Crystal Lake, IL (US)

(72) Inventor: Edward Steffes, JR., Woodstock, IL (US)

(21) Appl. No.: 19/173,706

(22) Filed: Apr. 8, 2025

Related U.S. Application Data
(60) Provisional application No. 63/631,412, filed on Apr. 8, 2024.

(51) Int. Cl. B65G 27/04; B65G 27/08; B65G 27/20

(52) U.S. Cl. CPC B65G 27/04; B65G 27/08; B65G 27/20; B65G 2811/095

(57) ABSTRACT

A vibratory apparatus includes a deck, an exciter, and a controller. The exciter is coupled to the deck. The exciter includes a shaft with at least one mass attached thereto, and a low-slip motor, such as a permanent magnet motor. The shaft is coupled to the deck via one or more resilient members.

This patent application claims the benefit of U.S. Provisional Patent Application No. 63/631,412, filed Apr. 8, 2024, which application is hereby incorporated herein by reference.

### BACKGROUND

This patent application is directed to a two-mass vibratory apparatus including an exciter with a low-slip motor, the operation of the exciter causing material to move relative to a deck of the vibratory apparatus.

Certain vibratory apparatuses are built by attaching an exciter directly to a trough, and operating the exciter to cause movement of materials in the trough relative to the trough. In a very simple example, a single motor may be fixedly attached to the trough, with an eccentric attached to the shaft. According to another example, a pair of motors may be fixedly attached to a trough, with at least one eccentric attached to a shaft of each of the motors. By varying the operation of the motors (e.g., turning one off while the other is on), materials may be moved from one end of the trough to the other.

In the alternative, the motors may be attached to the trough using a reactor spring, such as coil spring for example. This arrangement (also referred to as a two-mass system) may have advantages relative to the arrangement where the motors are attached directly to the trough (also referred to as a single mass, or brute force, system). Less energy may be required with the two-mass vibratory apparatus, because energy is used and stored in the springs. The two-mass system may also be more flexible in addressing changes in material in the trough, such as weight or density.

While two-mass systems may provide certain advantages over single-mass systems, not all two-mass configurations provide the same performance. It would be advantageous to overcome or substantially ameliorate one or more of the disadvantages of existing two-mass vibratory apparatuses in a two-mass configurations of novel and inventive design and/or control, or at least to provide a useful alternative.

### SUMMARY

According to one aspect of the present disclosure, a vibratory apparatus includes a deck, an exciter, and a controller. The exciter is coupled to the deck. The exciter includes a shaft with at least one eccentric mass attached thereto, a low-slip motor. The shaft is coupled to the deck via one or more resilient members. According to certain embodiments, the exciter may include a frequency drive coupled to the low-slip motor.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a side view of an embodiment of a vibratory apparatus;

FIG. 2 is a schematic view of an embodiment of a control system for use with the vibratory apparatus of FIG. 1;

FIG. 3 is a schematic view of another embodiment of a control system for use with a vibratory apparatus;

FIG. 4 is a schematic view of a further embodiment of a control system for use with a vibratory apparatus;

FIG. 5 is a perspective view of another embodiment of a vibratory apparatus;

FIG. 6 is an end view of the vibrator apparatus of FIG. 5;

FIG. 7 is an end view of a further embodiment of a vibratory apparatus; and

FIG. 8 is an end view of a still further embodiment of a vibratory apparatus.

### DETAILED DESCRIPTION OF VARIOUS EMBODIMENTS

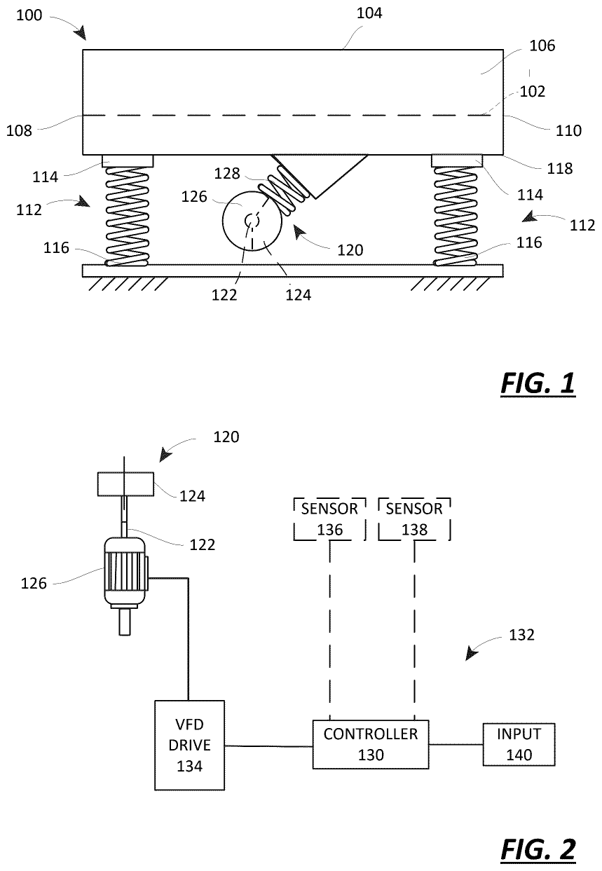

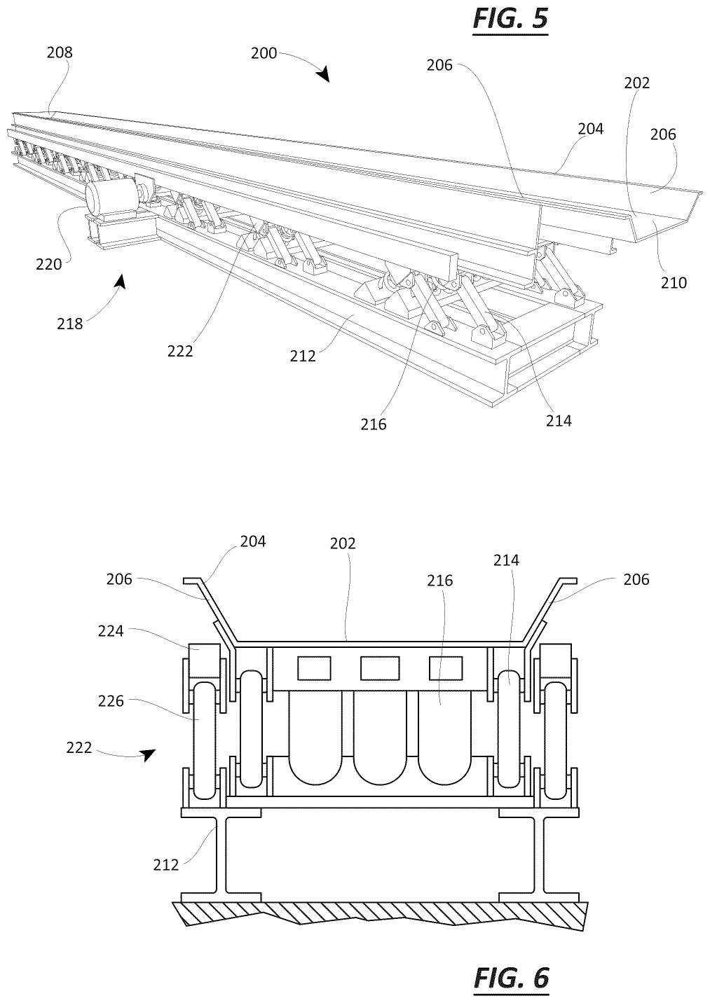

A vibratory apparatus according to embodiments of the present disclosure is illustrated in FIGS. 1 and 2. As illustrated, the vibratory apparatus of FIGS. 1 and 2 may be referred to as a feeder, although the vibratory apparatus according to embodiments of the present disclosure is not so limited. See FIGS. 5-8.

Turning first to FIG. 1, the apparatus 100 may include a deck 102. As illustrated, the deck 102 may be part of a trough 104. The trough 104 includes the deck 102 and one or more sidewalls 106. In FIG. 1, the trough 104 includes two opposing sidewalls 106 disposed on either side of the deck 102, the foremost of which is visible in FIG. 1.

According to certain embodiments, the deck 102 may have a solid surface, i.e., one that does not have openings, holes, or passages therethrough. As such, materials move along and across the deck 102 from a first end 108 to a second end 110. According to other embodiments, the deck 102 may have a perforated surface, i.e., one that has openings, holes, or passages therethrough. As such, as materials move along the deck 102, the materials (or a fraction thereof) can move across the deck from a first end 108 to a second end 110 or through the deck 102 from above the deck 102 to below the deck 102. As a further alternative, air may be passed through a perforated deck 102 to mix with the materials moving along and across the deck 102.

The trough 104, and particularly the deck 102, is supported above a surface. The trough 104 may be supported above the surface by suspending the trough 104 from a structure disposed above the trough 104, or by supporting the trough 104 from below the trough 104. As illustrated, the trough 104 is supported by a plurality of resilient members 112 disposed below the trough 104.

According to illustrated embodiment, the resilient members 112 (which may be referred to as isolation springs) may be in the form of coil springs, although other resilient members, such as rubber (marshmallow) springs or slats, may be used instead. The resilient members 112 may be attached at a first end 114 to the trough 104 and at a second end 116 to the surface (which may be referred to as “ground” although it may be a second story of a multi-story building, for example), often via a support structure that may be bolted or otherwise secured to the surface.

The trough 104 may include other features as well. For example, the trough includes a floor 118 beneath the deck 102, as illustrated. As such, materials passing through a perforated deck 102 may be deposited on the floor 118 and move along the floor 118. Alternatively, the sidewalls 106, the floor 118 and end walls (at ends 108, 110) may define a plenum below a perforated deck 102 for the introduction of air, for example, through the deck 102 into the materials moving across the deck 102. As a further alternative, the floor 118 may be omitted, and there may be an opening beneath the deck 102.

One or more exciters 120 may be coupled to the deck 102, for example via the attachment of the exciter(s) 120 to the through 104. The exciter 120 may include a shaft 122 to which at least one (one or more) eccentric mass(es) (or weight(s)) 124 are attached. The exciter 120 may also include a motor 126.

According to certain embodiments, the motor 126 may include a motor shaft, and the motor shaft may be the shaft 122 to which the at least one eccentric mass 124 is attached. See FIG. 2. According to such an embodiment, the motor 126 may be coupled to the trough 104. See FIG. 1. According to alternative embodiments, the motor 126 may include a motor shaft, and the motor shaft may be coupled to the shaft 122 and mass(es) 124, with the shaft 122 and mass(es) 124 coupled to the trough 104. According to the alternative embodiments, the motor 126 may be disposed on the ground.

The motor 126, shaft 122, and masses 124 (or alternatively the shaft 122 and masses 124) may be coupled to the trough 104 via one or more resilient members 128, as illustrated. The resilient members 128 may include one or more coil springs, and may be referred to as reactor springs. For purposes of this application, the resilient members 128 may be referred to as part of an exciter assembly, which will be referred to herein as the exciter 120 for ease of reference.

According to the embodiments of the present disclosure, the motor 126 is a low-slip or no-slip motor, i.e., one in which there is little to no measurable slip. That is, unlike a motor (like an induction motor) where there is a difference (often sizable) between the motor's actual and synchronous speeds, the motor 126 experiences little to no difference. Stated slightly differently, there is little to no difference between the rotating speed of the shaft (rotor) and the speed of the motor's magnetic field (which may be referred to as the speed of the stator or stator field) in a low-slip or no-slip motor. The terms are used herein with the understanding that even a no-slip motor may experience some measurable slip.

According to certain embodiments, the motor 126 is a permanent magnet motor. A permanent magnet motor will be used in conjunction with a variable frequency drive, as illustrated below, to provide accurate speed control. Accurate speed control is particularly important in a two-mass vibratory apparatus, where there is an advantage in the apparatus 100 being able to reliably reproduce the performance of the apparatus 100 as observed by a manufacturer once the apparatus 100 has been transported and placed in the final installation location.

The permanent magnet motor 126 is believed to provide certain technical advantages over the use of an induction motor, which is the conventional motor used in vibratory apparatuses, such as the apparatus 100.

A permanent magnet motor 126 provides high starting torques. This is believed to be advantageous in a device, like the apparatus 100 above and the other apparatuses discussed below, which operate according to natural frequency conveying. In these apparatuses, the spring systems are engineered and tuned to the weight of the conveying trough material. When the apparatus operates near its natural frequency, a significant percentage (e.g., more than 90%) of the driving force is provided by the spring system. The high starting torques provided by the motor 126 facilitate a quick increase to the designed motor speed and through other frequencies that do not provide the operational advantages of those frequencies near the natural frequency.

A permanent magnet motor 126 is also believed to permit more precise control than an induction motor, which by its nature requires slip to operate. In particular, as explained below, the motor 126 may be used with feedback to respond to the effective material weight on the apparatus 100. With an induction motor, the speed of the rotor (connected to the eccentric weight directly or indirectly) will decrease until the motor achieves its slip speed. This mode of operation will cause or create a period of time in which a variance in material flow control may occur, with high slip motors providing an even greater variances. The changing speed causes the stroke to decrease as the apparatus operates at vibration speeds distant from the natural frequency of the apparatus 100 as loaded. With a permanent magnet motor, the speed of vibration may be held at a particular speed, and as material is loaded on the apparatus 100, the stroke can be controlled (through the speed of the motor) to prevent an increase in stroke and to limit material flow variances.

Further, without the need for the windings present in an induction motor, it is believed that the permanent magnet motor 126 provides advantageous tradeoffs in size, weight, and power not possible for an induction motor. For example, the reduction in the physical size of the rotor may permit the overall size of a permanent magnet motor providing the same horsepower as an induction motor to be smaller. Alternatively, a rotor capable of providing a higher horsepower may be placed in a motor housing (or the space occupied by a motor housing) of a lower horsepower induction motor. Moreover, if a physically smaller motor is used to produce the same horsepower as an induction motor, this smaller motor would add less weight to the exciter. This could result in an overall lighter exciter, or permit different weight distributions or design considerations not possible with the larger, heavier induction motor.

A first embodiment of a permanent magnet motor 126 according to the present disclosure may have a cylindrical rotor. One or more (e.g., four) permanent magnets may be disposed about the perimeter of the rotor radially outward from and parallel to an axis of rotation of the rotor. The magnets may be spaced about the rotor, preferably symmetrically.

The angle between the magnetic field of the stator and that of the rotor may be controlled to control the torque produced by the motor, to reduce energy losses and improve efficiency relative to the induction motor.

A second embodiment of a permanent magnet motor 126 (which may be referred to as a permanent magnet synchronous reluctance motor because it represents a combination of a permanent magnet motor design and a reluctance motor design) may have a cylindrical rotor (preferably of iron). One or more (e.g., four) slots may be formed therethrough parallel to an axis of rotation of the rotor. The slots may be spaced about the rotor, preferably symmetrically.

One or more (e.g., eight) permanent magnets are disposed in the slots (e.g., two per slot). The slots may have a curved shape, with the ends of the curve closer to the perimeter of the rotor and the center of the curve closer to the axis of the rotor. The magnets may be disposed, according to one embodiment, closer to the ends of the curve than its center and with a gap between the magnets.

It is believed that the second embodiment of the permanent magnet motor 126 may be controlled to perform better at high rotor speeds than the first embodiment of the permanent magnet motor 126. In particular, it is believed that the second embodiment may be controlled to reduce back electromotive forces and eddy current losses (with attendant heat produced). As such, this second embodiment is believed to overcome overheating at high speeds.

Still further modifications are possible as to the second embodiment, as to the rotor, the slots, the magnets etc. For example, each of the magnets may be segmented into one or more (e.g., four) parts. It is believed that such segmentation may reduce eddy current in the magnets, reducing heating and potential demagnetization.

The operation of the exciter 120 may be controlled by a controller 130 that may be coupled to the exciter 120 and particularly to the motor 126. The controller 130 may be programmable, and may control the operation of the exciter 120 such that objects move along the deck 102 with a constant amplitude or with different amplitudes at different times.

To control the operation of the motor 126, a control system 132 may be defined that includes the controller 130 and a variable frequency drive (VFD) 134 coupled to the motor 126. The drive 134 controls the frequency (and consequently the speed) of the respective motor 126 and thus the speed of the shaft 122.

The controller 130, as well as the drive 134, may be defined by one or more electrical circuit components, may be defined by one or more processors that may be programmed to perform the actions of the controller or drive, or in part by electrical circuit components and in part by a processor(s) programmed to perform the actions of the controller or drive. The instructions by which the processor(s) is/are programmed may be stored on a memory associated with the processor, which memory may include one or more tangible non-transitory computer readable memories, having computer executable instructions stored thereon, which when executed by the processor, may cause the one or more processors to carry out one or more actions described herein. Because the controller or drive may include one or more processors, the controller or drive configured to carry out an action may be referred to as being programmed to carry out the action with reference to those embodiments utilizing a programmable processor.

The controller 130 may operate the drive 134. In addition, the control system 132 may include an optional sensor 136, such as an accelerometer, coupled to the controller 130 to provide feedback to control the amplitude (stroke). Thus, according to one such embodiment, the sensor 136 is an accelerometer. According to a further embodiment, the sensor 136 is an accelerometer in the form of a triaxial accelerometer and is attached to the exciter 120.

According to another embodiment, an additional sensor 138 is provided. The sensor 138 may be an accelerometer coupled to the controller 130 and attached to the trough 104. The controller 130 uses the optional accelerometer 138 to compare the amplitude of the exciter 120 with the amplitude of the trough 104 to determine what, if any, modifications may be required to obtain a desired amplitude for the trough 104. That is, when the trough 104 is loaded with material, there may be a difference between the amplitude of the exciter 120 relative to the trough 104. By attaching a sensor to the trough 104, the differences between the amplitudes may be controlled in a closed-loop fashion such that the amplitude experienced by material in the trough 104 may match that provided by an operator via an input 140.

Further, while the operation of the control system 132 has been discussed above with reference to a single amplitude provided via an input 140, it is also possible that the controller 130 is configured to provide multiple amplitudes in response instead of a single amplitude. For example, the controller 130 may control the drive 134 such that the apparatus 100 provides vibration according to first amplitude for a first period, according to a second amplitude for a second period, and a third amplitude (which may or may not match the first amplitude) for a third period. The input 140 may be used to change the amplitudes either before the controller 130 begins operation of the apparatus 100, or as the controller 130 is operating the apparatus 100.

While the illustrated embodiment includes a single exciter 120, according to other embodiments, more than one exciter 120 may be provided. For example, two exciters 120 may be coupled to the deck 102. In such a case, the exciters 120 may be operated in sequence or simultaneously to provide a particular amplitude or sequence of amplitudes.

In the embodiment of FIGS. 1 and 2, the low-slip motor 126 is coupled to a frequency drive 134. The frequency drive 134 is in turn coupled to the controller 130. The controller 130 may use the frequency drive 134 to move the rotor of the low-slip motor 126, for example a permanent magnet motor, to a correct angle relative to the magnetic field to start the rotation of the rotor of the motor 126.

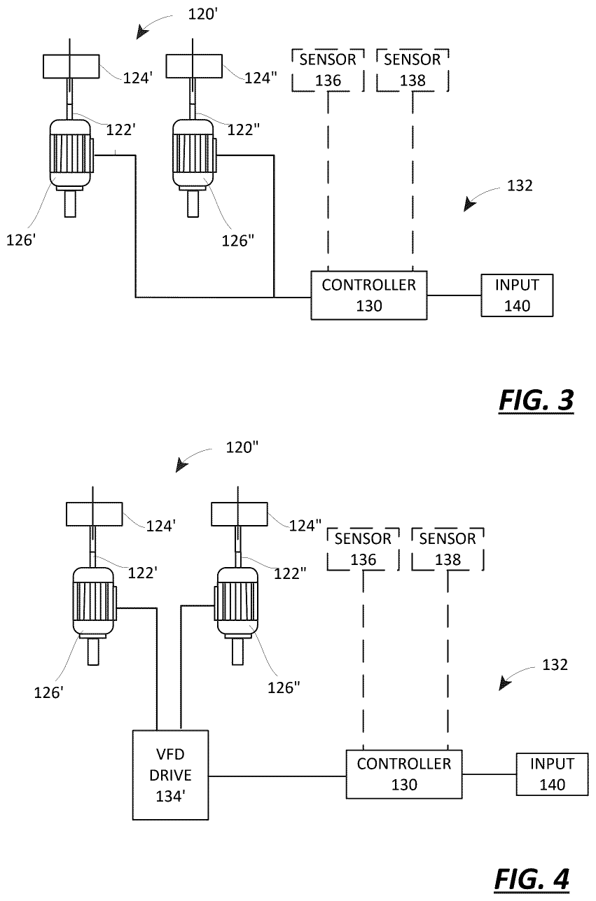

It is believed that not all embodiments of a permanent magnet motor will require a frequency drive to start rotation. Instead, the motor may be connected across the line directly. The controller would then be coupled directly to the motor to control the motor, e.g., on and off. See, e.g., motor 126′, FIG. 3, wherein elements in common with FIGS. 1 and 2 are numbered identically, and different elements are numbered with a prime or double prime. Indeed, the controller 130 may be coupled directly to the motor 126′ as well as at least another low-slip motor 126″, that is a plurality of low-slip motors.

It will be recognized that without the frequency drive coupled to the motor 126′, 126″, the frequency of the motor 126′, 126″ cannot be changed. Still, such an embodiment would permit a permanent magnet motor (or motors) to be designed and used in a particular or specific installation according to the frequency of the motor(s).

This is not to suggest that an embodiment of a permanent magnet motor that does not require a frequency drive to move the rotor to the correct angle to start rotation could not or would not be used with a frequency drive. It will be recognized that by combining such a permanent magnet motor with a frequency drive, the frequency/speed of the motor may be varied to provide greater flexibility in operation.

Indeed, if an embodiment of low-slip motor is used that does not require the use of a frequency drive to start the rotation of the motor, additional options are possible. For example, as illustrated in FIG. 4, a single variable frequency drive 134′ could be used to operate a plurality of motors (i.e., a motor 126′ and at least another motor 126″). That is, if a variable drive is required, then there is a one-to-one correspondence between the frequency drive and the motor, and a master/slave correspondence must be established. Without this requirement, a single variable frequency drive 134′ could be coupled to the plurality of motors 126′, 126″, potentially with an overload disposed between the variable frequency drive and the plurality of motors. The drive 134″ could then vary the frequency/speed of all associated motors 126′, 126″.

According to still other embodiments, a plurality of frequency drives and a plurality of motors may be used, wherein each of the frequency drives is coupled to a plurality of motors. The plurality of the frequency drives may be coupled to the controller, and each of the frequency drives may be used to vary the frequency/speed of the associated plurality of motors.

As mentioned above, a vibratory apparatus is not limited to the embodiment illustrated in FIGS. 1 and 2. A series of related embodiments of a vibratory apparatus 200 according to the present disclosure are illustrated in FIGS. 5-8. Here as well, the intent is not to limit the embodiments to the vibratory apparatus 200 illustrated in FIGS. 5-8, which may be referred to as a conveyor, but to illustrate the variation among embodiments of the vibratory apparatus 100, 200 according to the present disclosure.

Turning to FIG. 5, the apparatus 200 includes a deck 202. The deck 202 is part of a trough 204, the trough 204 includes side walls 206 that depend upwards from either side of the deck 202. Material may move along the deck 202 from a first end 208 to a second end 210. The apparatus 200 is disposed on a base 212.

The trough 204, and thus the deck 202, may be disposed on the combination of links 214 and resilient members 216. While the resilient members 216 are illustrated in the form of coil springs, other types of resilient members may be used instead. The trough 204 may be coupled to a mechanism for providing reciprocating motion (or exciter), indicated generally at 218, which may include a motor 220 disposed to the side of the trough 204. Such mechanisms may be according to the embodiments illustrated in U.S. Pat. No. 3,750,866, for example, which patent is incorporated by reference herein in its entirety.

The motor 220 may be a no-slip or low-slip motor, for example a permanent magnet motor, as described above. While the structure of the apparatus 200 may differ from that of apparatus 100, the operation of the motor 220 in conjunction with an embodiment of vibratory apparatus as illustrated in FIGS. 5-8 is believed to have the same operation and benefits as described above. Consequently, the disclosure above as to the operation and benefits of the no-slip motor 126 is adopted herein as well.

In the apparatus 200 according to FIG. 5, it may be desirable to reduce or limit the transmission of forces to the surrounding supports or building. To this end, a counterpoise may be used to absorb or isolate the reaction forces. See FIGS. 6-8. Such a counterpoise may absorb or isolate a significant percentage of the reaction forces. For example, the counterpoise may absorb or isolate up to 95% of the reaction forces. In this regard, see also U.S. Pat. No. 3,750,866, which is incorporated by reference herein in its entirety.

FIG. 6 illustrates a first embodiment of counterpoise 222, such as used in the embodiment of vibratory apparatus 200 illustrated in FIG. 5. The counterpoise 222 includes a frame 224 supported on the base 212 by reactor assemblies 226. Typically, the weight of the counterpoise frame 224 is equal to the weight of the trough 204. The frame 224 is positively driven 180° out of phase with the trough motion (or trough, for short). This results in an equal and opposite dynamic reaction along the rigidly mounted base 212 of the apparatus 200.

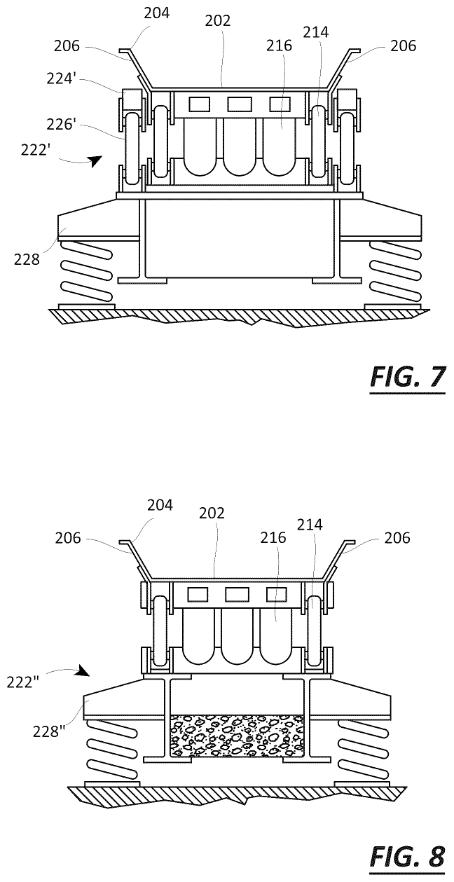

FIG. 7 illustrates a second embodiment of counterpoise that may be used instead of the first embodiment. Parts of this embodiment similar to that of the first embodiment are numbered similarly, with the addition of a prime. The counterpoise 222′ also includes a frame 224′ supported by reactor assemblies 226′. The frame 224′ is also positively 180° out of phase with the trough. Unlike the counterpoise of FIG. 7, the apparatus is mounted on a floating spring-mounted sub-base 228.

FIG. 8 illustrates a third embodiment of counterpoise that may be used instead of the first and second embodiments. Parts of this counterpoise are indicated with a double prime. This embodiment of counterpoise 222″ does not have a frame supported by reactor assemblies. Instead, the remained of the apparatus (trough 204 with deck 202 and sidewalls 206, links 214, and resilient members 216) is mounted on a floating spring-mounted sub-base 228″ counterweighted to provide a highly efficient counterpoise action 180° out of phase with the trough 204.

While three embodiments of counterpoise have been illustrated, other embodiments also exist. For example, two separate and distinct masses, one designed to carry material and the other designed to offset dynamic loads, may be used, with the masses normally running or operated 180° out of phase. As such, the illustrated embodiments are not intended to limit the embodiments of vibratory apparatus possible.

Although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A vibratory apparatus comprising:
a deck; and
an exciter coupled to the deck, the exciter comprising a shaft with at least one eccentric mass attached thereto, the shaft coupled to the deck via one or more resilient members, and a low-slip motor.

2. The vibratory apparatus of claim 1, wherein the exciter comprises a frequency drive coupled to the low-slip motor.

3. The vibratory apparatus of claim 2, further comprising a controller coupled to the frequency drive and configured to control the frequency drive to operate the motor, thereby causing the exciter to vibrate the deck to move materials along the deck.

4. The vibratory apparatus of claim 3, further comprising a sensor coupled to the controller, the controller configured to control the frequency drive according to a signal received from the sensor.

5. The vibratory apparatus of claim 4, wherein the sensor is attached to the exciter or the deck.

6. The vibratory apparatus of claim 1, further comprising a controller coupled directly to the low-slip motor to control the low-slip motor.

7. The vibratory apparatus of claim 6, further comprising at least another low-slip motor, the controller coupled directly to the low-slip motor and the at least another low-slip motor.

8. The vibratory apparatus of claim 1, further comprising at least another low-slip motor, a frequency drive coupled to the low-slip motor and the at least another low-slip motor, and a controller coupled to the frequency drive and configured to control the frequency drive to operate the low-slip motor and the at least another low-slip motor, thereby causing the exciter to vibrate the deck to move materials along the deck.

9. The vibratory apparatus of claim 1, wherein the low-slip motor is a permanent magnet motor.

10. The vibratory apparatus of claim 9, wherein the permanent magnet motor includes permanent magnets disposed about a perimeter of a rotor.

11. The vibratory apparatus of claim 9, wherein the permanent magnet motor includes permanent magnets disposed in at least one slot formed in a rotor.

12. The vibratory apparatus of claim 1, wherein the low-slip motor has a motor shaft, and the motor shaft is the shaft.

13. The vibratory apparatus of claim 1, wherein the low-slip motor has a motor shaft, and the shaft is coupled to the motor shaft.

14. The vibratory apparatus of claim 1, wherein the one or more resilient members comprise coil springs.

15. The vibratory apparatus of claim 1, further comprising a trough, the trough comprising the deck and opposing sidewalls disposed on either side of the deck.

16. The vibratory apparatus of claim 1, wherein the deck has a solid surface along with the materials may move.

17. The vibratory apparatus of claim 1, wherein the deck has a perforated surface.

18. The vibratory apparatus of claim 1, wherein the deck is supported on a surface by at least one or more resilient members.

19. The vibratory apparatus of claim 18, wherein the at least one or more resilient members comprise coil springs.
